(19) United States
(12) Patent Application Publication
(10) Pub. No.: US 2022/0066989 A1
(43) Pub. Date: Mar. 3, 2022

(54) TECHNIQUES FOR CASE INSENSITIVE LOOKUP AND CASE COLLISION DETECTION

(71) Applicant: Vast Data Ltd., Tel Aviv (IL)

(72) Inventors: Oded SONIN, Tel Aviv (IL); Avi GOREN, Tel Aviv (IL); Asaf LEVY, Tel Aviv (IL); Renen HALLAK, Tenafly, NJ (US)

(73) Assignee: Vast Data Ltd., Tel Aviv (IL)

(21) Appl. No.: 17/011,380

(22) Filed: Sep. 3, 2020

(51) Int. Cl. G06F 16/14; G06F 16/903

(52) U.S. Cl. CPC G06F 16/152; G06F 16/90335

(57) ABSTRACT

A system and method for case insensitive collision detection. A method includes searching a file system for a case sensitive version of a target file name, the file system having a plurality of file name entries and a plurality of hash entries; returning results of the first search when the case sensitive version of the target file name is found; and searching the file system for a case insensitive version of the target file name when the case sensitive version of the target file name is not found, wherein searching the file system for the case insensitive version of the target file name further comprises navigating from hash entries of the file system to file name entries of file system based on pointers of the hash entries and converting a stored file name of each of the file name entries into a case insensitive version.

### TECHNICAL FIELD

The present disclosure relates generally to searching file systems, and more specifically to providing case insensitive lookup and to preventing case collisions.

### BACKGROUND

For some operating systems, file names are case insensitive. In other words, the operating system will not distinguish between capitalized and lower case letters. As a result, it is desirable to provide mechanisms for performing case insensitive lookups. In some uses, it may be further desirable to ensure that the listing remains case insensitive. Existing solutions include some techniques for case insensitive lookups. For example, some existing solutions convert all versions of file names into case insensitive versions by changing all letters to either capital or lowercase by default. These solutions do not provide case sensitive file names and, as a result, may also face challenges with collisions between file names which are the same except for capitalization.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for case insensitive collision detection. The method comprises: searching, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names; returning results of the first search when the case sensitive version of the target file name is found during the first search; and searching, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

Certain embodiments disclosed herein also include a non-transitory computer readable medium having stored thereon causing a processing circuitry to execute a process, the process comprising: searching, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names; returning results of the first search when the case sensitive version of the target file name is found during the first search; and searching, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

Certain embodiments disclosed herein also include a system for case insensitive collision detection. The system comprises: a processing circuitry; and a memory, the memory containing instructions that, when executed by the processing circuitry, configure the system to: search, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names; return results of the first search when the case sensitive version of the target file name is found during the first search; and search, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for adding case insensitive entries to a file system using case insensitive collision detection according to an embodiment.

FIG. 3 is a flowchart illustrating a method for establishing a case insensitive file system scheme according to an embodiment.

FIG. 4 is a flowchart illustrating a method for case insensitive lookup according to an embodiment.

FIG. 5 is a schematic diagram of a file system manager according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It has been identified that solutions for case insensitive lookup which retains the case sensitivity of case sensitive file names while preventing case collisions are desirable. To this end, the disclosed embodiments provide techniques allowing for case insensitive lookup and techniques for ensuring that new or upgraded case insensitive entries do not conflict with other entries.

The various disclosed embodiments include methods and systems for case insensitive collision detection and applications thereof. The various disclosed embodiments include a method for performing case insensitive lookups in file systems using case collision detection. A request for a file name lookup including a case sensitive version of a file name is received. A file system is searched for the case sensitive file name. When the case sensitive file name is not found, the file system is searched for a case insensitive version of the file name. The results of at least the first or the second search are returned.

The disclosed embodiments also include a method for adding a file to a file system using case insensitive collision detection includes creating a file name entry for an original version of a case sensitive file name in a write buffer when a new file name link is to be created. The file name entry includes the original case sensitive file name. A file system including case insensitive file name entries is checked for conflicts with a case insensitive version of the file name. When a collision is detected, the creation of the new file name link is blocked. When a collision is not detected, the new file name link is created. The new file name link points to the created file name entry with the original case sensitive file name.

When a file system is not already configured with case insensitive file names, an upgrade procedure may be performed. During the upgrade procedure, a file system is scanned for entities including file names. Each file name entry is tentatively marked as case sensitive by, for example, modifying a binary value representing the case insensitive status to false. Case insensitive file names are generated based on original case sensitive file names. The entries are updated to include the case insensitive file names. When the entries have been updated, the entries are marked to indicate that the entries are case insensitive by, for example, modifying a binary value representing the case insensitive status to true. When the file system has been upgraded, subsequent new entries are created by converting new file names to case insensitive file names and storing the converted new file names in new entries.

The disclosed embodiments provide techniques which allow for providing case insensitive file collision detection while maintaining the case sensitivity of file name entries. Further, the disclosed embodiments provide techniques allowing for upgrading existing systems which are not already configured for case insensitive lookups and collision detection.

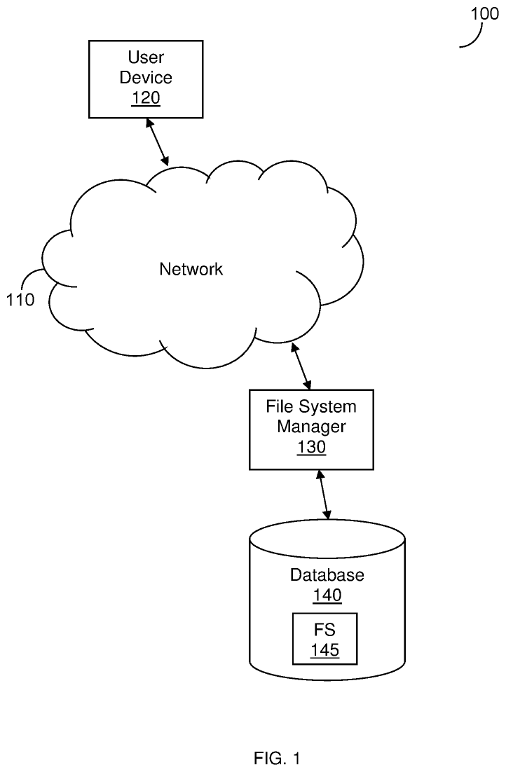

FIG. 1 shows an example network diagram 100 utilized to describe the various disclosed embodiments. In the example network diagram 100, a user device 120, a file system manager 130, and a database 140 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving and displaying notifications. The user device 120 is configured to send requests requiring file name lookups to the file system manager 130 and to receive results of file system searches from the file system manager 130.

The file system manager 130 is configured to perform collision detection and case insensitive lookup as described herein. More specifically, the file system manager 130 is configured to perform these functions with respect to a file system (FS) 145 stored in the database 140.

It should be noted that the example network diagram depicted in FIG. 1 is merely an example utilized to aid in describing an environment to which various disclosed embodiments may be applied, and is not limiting on the disclosed embodiments. The disclosed embodiments may be equally applied to other network configurations. As a non-limiting example, the file system 145 may be integrated within the file system manager 130 instead of in a separate database 140. As another non-limiting example, although the file system manager 130 and the database 140 are illustrated as communicating directly, the file system manager 130 and the database 140 may communicate over a network 110.

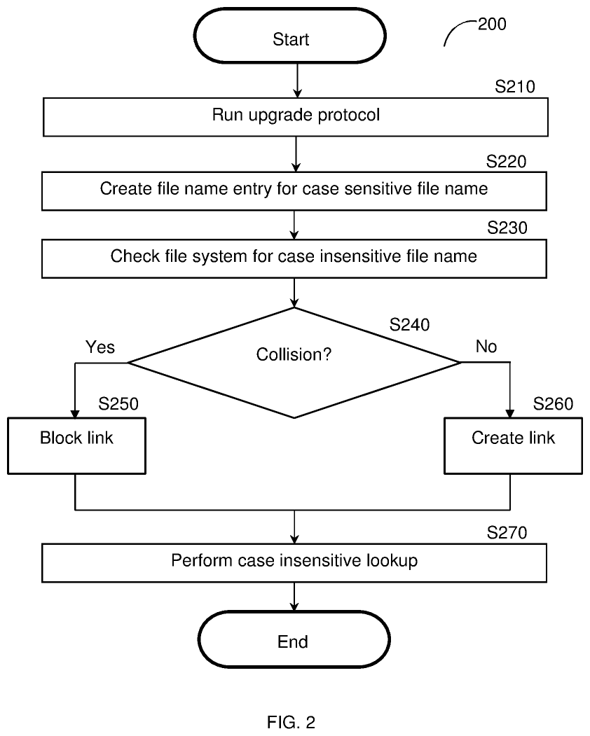

FIG. 2 is a flowchart 200 illustrating a method for adding case insensitive entries to a file system using case insensitive collision detection according to an embodiment. In an embodiment, the method is performed by the file system manager 130, FIG. 1.

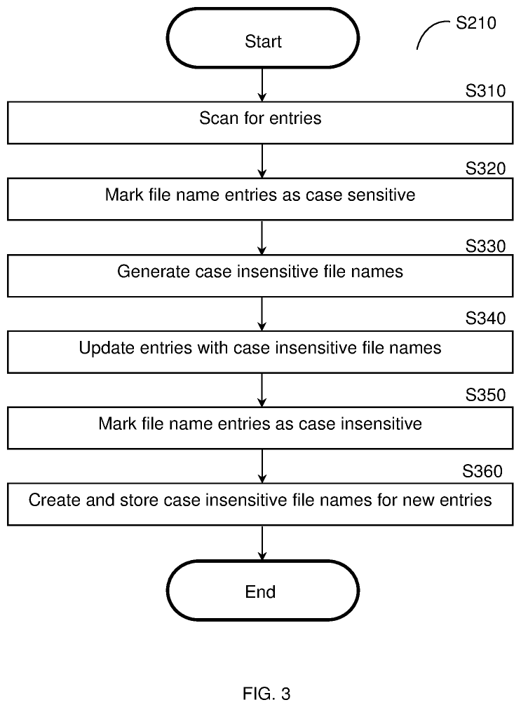

At optional S210, an upgrade protocol is run. The upgrade protocol may be utilized to upgrade an existing file system that is not configured for case insensitive lookup and collision detection. In some implementations, the upgrade protocol may be run as a background process. An example method for performing such an upgrade is now described with respect to FIG. 3.

FIG. 3 is a flowchart S210 illustrating a method for establishing a case insensitive file system scheme according to an embodiment.

At S310, the file system is scanned for file name entries.

At S320, the file name entries found at S310 are marked as case sensitive. In an embodiment, each entry includes a value representing a status indicating whether the entry is case sensitive or not, and S320 includes changing the value to indicate that the file name of the entry is case sensitive. In an example implementation, such a value may be a binary value where 0 (false) indicates that the file name is case sensitive and 1 (true) indicates that the file name is case insensitive, and S320 includes changing all instances of that value to 0.

In an example implementation, while the file name entries are marked as case sensitive, any operations requiring case insensitivity (e.g., operations including case insensitive lookups or collision detection as described herein) will not be allowed to proceed. To this end, in an example implementation, any such operations may fail or may stall until upgrading is complete.

At S330, case insensitive file names are generated based on the case sensitive file names of the entries. As noted above, the letters of the case insensitive file names may be either all uppercase letters or all lowercase letters. The letters of each case insensitive file name consist of either all lowercase letters or all uppercase letters.

At S340, the entries are updated with their respective case insensitive file names.

In an embodiment, S340 may further include creating hash entries for a hash tree based on the case insensitive file names and adding those hash entries to the hash tree.

At S350, the updated entries are marked as case insensitive. In an example implementation, S350 includes changing the binary values representing case sensitivity status to 1 (true).

At S360, when the existing entries have been updated in accordance with S310 through S350, all subsequent new entries are initialized by creating and storing case insensitive file names instead of the case sensitive file names. To this end, when a new file name to be added as a file name entry is received, a case insensitive version of the file name is generated and added to a new file name entry.

When the upgrade is complete, subsequent attempts to add new file entries will scan the file system for collisions. As noted herein, the file system may include both hash entries including hashes of at least case insensitive file names and corresponding file name entries including case sensitive file names. Each entry may further include a flag or other marker indicating whether the entry is case sensitive or case insensitive.

When a request for a listing of file names in a directory of the file system is received, hash name entries of the file system are searched in order to find the file names. In an example implementation, only case sensitive file names are provided in such a listing to avoid providing redundant results. To this end, in such an implementation, hash entries marked as case insensitive may be skipped when searching the file system in order to provide a listing of file names.

Additionally, when the upgrade is complete, all asynchronous name maintenance processes will include traversing both case sensitive and case insensitive file names in order to ensure that any changes are consistent throughout the file system. Some operations (e.g., read operations) may only require traversing one or the other since links between entries based on case insensitive file names should point to their case sensitive counterparts and vice versa.

Returning to FIG. 2, at S220, a file name entry is created. In an embodiment, S220 is performed when a request to store a new file name is received. The file name entry includes the case sensitive file name pointing to a file having the case sensitive file name. The file name entry may point to the file by including a pointer indicating a location in storage of the file or by including a pointer to another entry indicating a location in storage of the file. The case sensitive file name is the file name with all case sensitive capitalization and may be, for example, the new file name to be stored.

In an example implementation, the file name entry is created in a write buffer. In a further example implementation, the write buffer may be stored in a first storage, and contents of the write buffer are transferred to a second storage once the file name entry is finalized. The first storage may be a relatively fast storage as compared to the second storage, but may only be used to store data temporarily.

At S230, a file system is checked for a case insensitive file name. In an embodiment, S230 includes generating a case insensitive file name based on the case sensitive file name. The letters of the case insensitive file name consist of either all lowercase letters or all uppercase letters. As a non-limiting example, the case insensitive file name is “foo” (all lowercase) when the case sensitive file name is any of “FOO”, “foo”, “FoO”, “fOo”, “foO”, “FOo”, “Foo”, and “fOO.”

At S240, it is determined whether a collision is detected and, if so, execution continues with S250; otherwise, execution continues with S260. In an embodiment, S240 includes scanning the file system for the case insensitive file name.

At S250, when it is determined that a collision is detected, insertion of the file name in a file system is blocked and execution continues with S270.

At S260, when it is determined that a collision has not been detected, the file name is inserted into a file system and execution continues with S270. In an embodiment, S260 includes adding the case insensitive file name to a file name tree. An entry for the case insensitive file name in the file name tree is marked as being case insensitive, for example as described above with respect to S320.

In a further embodiment, S260 includes inserting a hash representing the case insensitive file name to a hash tree including hashes representing file names of the file name tree.

Use of the hash tree speeds up subsequent file name lookups. More specifically, instead of searching through all name entries, a hash may be generated based on a file name to be searched and the hash is compared to hashes in the hash tree. When a match is found, a respective file name associated with the matching hash is converted to a case insensitive version and compared to the file name being looked up. This allows for identifying potential matches by comparing hashes, which is faster and utilizes fewer computing resources than comparing file names directly. This, in turn, reduces the number of comparisons between file names that are needed since file names are only compared when a hash match is found.

In yet a further embodiment, both a hash representing the case insensitive file name and a hash representing the original case sensitive file name are added to the hash tree. Storing both of these hashes in an entry in the hash tree ensures that each entry is unique per case sensitive name.

In an optional embodiment, a secondary key may be added to the entry in the file name tree. The secondary key indicates a hash representing the original case sensitive file name. The secondary key allows for maintaining information related to the case sensitive version of the file name such that a split occurs when multiple case sensitive file names share a common case insensitive file name. Maintaining such secondary keys allows for supporting multiple protocols and, in particular, protocols which use case sensitive lookup or collision detection in addition to the case insensitive techniques described herein.

As a non-limiting example for a secondary key, for the original case sensitive file name “Foo”, the secondary key may be “<foo, 100>”, while the secondary key for the original case sensitive file name “fOo” may be “<foo, 010>.” When the case insensitive file name is the same as the case sensitive file name, the hash representing the case insensitive file name may be a null value or all false (e.g., “<foo, 000>” for “foo”).

In a non-limiting example implementation, the file name entry, the hash entry, or both, may be inserted into respective blocks of an element store as described in U.S. Pat. No. 10,656,857, assigned to the common assignee, the contents of which are hereby incorporated by reference. More specifically, hash entries may be stored in respective bitmap blocks, which in turn point to respective content blocks including the file name entry corresponding to each hash. The content blocks may, in turn, point to a respective file associated with each file name. Hash entries may be organized using ranges of range blocks, each range block pointing to hash blocks having hashes of file names in a respective range of file names, and may be mapped using a hash table distributed among hash table blocks. Storing hash entries such that they are traversed prior to arriving at file name entries reduces use of computing resources and increases speed by only analyzing file names when a matching hash is identified.

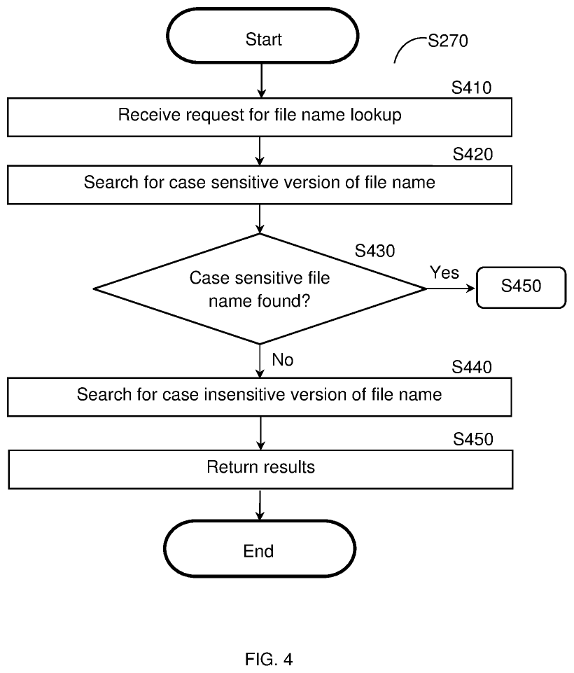

At optional S270, case insensitive lookup is performed. An example method for performing case insensitive lookup is now described with respect to FIG. 4.

FIG. 4 is a flowchart S270 illustrating a method for case insensitive lookup according to an embodiment.

At S410, a request for a file name lookup is received (for example, from the user device 120, FIG. 1). The request includes a case sensitive file name, i.e., a file name with all case sensitive capitalization intact.

At S420, a file system is searched for the case sensitive file name.

At S430, based on the search, it is determined if the case sensitive file name has been found and, if so, execution continues with S450; otherwise, execution continues with S440.

At S440, when the case sensitive file name has not been found, the file system is searched for a case insensitive version of the file name. The letters of the case insensitive file name consist of either all uppercase or all lowercase letters. In an embodiment, S440 includes converting the case sensitive file names indicated in file name entries into case insensitive versions thereof.

In a further embodiment, only a portion of the file system is searched for the case insensitive version of the file name. More specifically, a portion of the file system having a range that would include the case insensitive file name is searched. In an example implementation, a hash is generated for the case insensitive file name and utilized to determine if any matching hashes are identified. It has been identified that such a hash-based search may result in a false positive, i.e., a determination that a matching entry exists based on hash when the entries do not actually match. To this end, in yet a further embodiment, when a matching hash is found, an original file name associated with the hash is converted to a case insensitive version and compared to the case insensitive version of the requested file name.

At S450, results of searching the file system are returned.

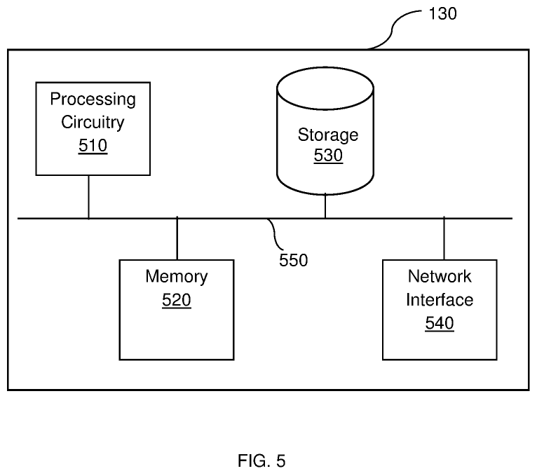

FIG. 5 is an example schematic diagram of a file system manager 130 according to an embodiment. The file system manager 130 includes a processing circuitry 510 coupled to a memory 520, a storage 530, and a network interface 540. In an embodiment, the components of the file system manager 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information. [0060]The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk- read only memory (CD-ROM), Digital Versatile Disks (DVDs), or any other medium which can be used to store the desired information.

The network interface 540 allows the file system manager 130 to communicate with the user device 120 for the purpose of, for example, receiving requests for file name lookups, receiving file names to be added to the file system, returning results of file name lookups, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for case insensitive collision detection, comprising:
searching, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names;
returning results of the first search when the case sensitive version of the target file name is found during the first search; and
searching, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

2. The method of claim 1, wherein the plurality of hashes further includes a plurality of hashes of case insensitive versions of the plurality of case sensitive stored file names, wherein searching the file system for the case insensitive version of the target file name further comprises:
generating a hash of the case insensitive version of the target file name;
identifying a matching hash entry by searching at least one first hash entry of the plurality of hash entries for the hash of the case insensitive version of the target file name, wherein the at least one pointer of the matching hash entry points to the at least one first file name entry of the plurality of file name entries; and
comparing the case insensitive version of the target file name with the case insensitive version of each stored file name of the at least one first file name entry, wherein results of the second search are determined based on the comparison.

3. The method of claim 2, wherein the file system further includes a plurality of range entries, each range entry including a range of case sensitive file names and pointing to at least one hash entry of the plurality of hash entries, wherein searching the file system for the case insensitive version of the target file name further comprises:
navigating from the plurality of range entries to the at least one first hash entry of the plurality of hash entries.

4. The method of claim 1, further comprising:
creating a target file name entry including the case sensitive version of the target file name;
blocking insertion of the target file name entry to the file system when a collision is detected during the first search or during the second search; and
inserting the target file name entry to the file system when a collision is not detected during the first search or during the second search.

5. The method of claim 4, further comprising:
inserting a target hash entry to the file system, wherein the target hash entry includes a hash representing the case insensitive version of the target file name and points to the target file name entry.

6. The method of claim 5, wherein the target hash entry further includes a hash representing the case sensitive version of the target file name.

7. The method of claim 1, further comprising:
upgrading the file system for case insensitive operations by generating at least one case insensitive hash entry based on at least one case sensitive stored file name of the plurality of case insensitive stored file names and adding the at least one case insensitive hash entry to the plurality of hash entries.

8. The method of claim 7, wherein upgrading the file system further comprises:
marking the at least one case sensitive stored file name as case sensitive;
updating each of the plurality of file name entries to further include a case insensitive version of the respective file name of the file name entry; and
marking the updated file name entries as case insensitive.

9. A non-transitory computer readable medium having stored thereon instructions for causing a processing circuitry to execute a process, the process comprising:
searching, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names;
returning results of the first search when the case sensitive version of the target file name is found during the first search; and
searching, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

10. A system for case insensitive case insensitive collision detection, comprising:
a processing circuitry; and
a memory, the memory containing instructions that, when executed by the processing circuitry, configure the system to:
search, during a first search, a file system for a case sensitive version of a target file name, the file system having a plurality of file name entries and a plurality of hash entries, the plurality of file name entries including a plurality of case sensitive stored file names, the plurality of hash entries including a plurality of hashes and a plurality of pointers to corresponding file name entries of the plurality of file name entries, wherein the plurality of hashes include a plurality of hashes of the plurality of case sensitive stored file names;
return results of the first search when the case sensitive version of the target file name is found during the first search; and
search, during a second search, the file system for a case insensitive version of the target file name when the case sensitive version of the target file name is not found during the first search, wherein searching the file system for the case insensitive version of the target file name further comprises navigating from the plurality of hash entries to at least one first file name entry of the plurality of file name entries based on the pointers of the plurality of hash entries and converting the stored file name of each of the at least one first file name entry into a case insensitive version.

11. The system of claim 10, wherein the plurality of hashes further includes a plurality of hashes of case insensitive versions of the plurality of case sensitive stored file names, wherein the system is further configured to:
generate a hash of the case insensitive version of the target file name;
identify a matching hash entry by searching at least one first hash entry of the plurality of hash entries for the hash of the case insensitive version of the target file name in order to identify a matching hash entry, wherein the at least one pointer of the matching hash entry points to the at least one first file name entry of the plurality of file name entries; and
compare the case insensitive version of the target file name with the case insensitive version of each stored file name of the at least one first file name entry, wherein results of the second search are determined based on the comparison.

12. The system of claim 11, wherein the file system further includes a plurality of range entries, each range entry including a range of case sensitive file names and pointing to at least one hash entry of the plurality of hash entries, wherein the system is further configured to:
navigate from the plurality of range entries to the at least one first hash entry of the plurality of hash entries.

13. The system of claim 10, wherein the system is further configured to:
create a target file name entry including the case sensitive version of the target file name;
block insertion of the target file name entry to the file system when a collision is detected during the first search or during the second search; and
insert the target file name entry to the file system when a collision is not detected during the first search or during the second search.

14. The system of claim 13, wherein the system is further configured to:
insert a target hash entry to the file system, wherein the target hash entry includes a hash representing the case insensitive version of the target file name and points to the target file name entry.

15. The system of claim 14, wherein the target hash entry further includes a hash representing the case sensitive version of the target file name.

16. The system of claim 10, wherein the system is further configured to:
upgrade the file system for case insensitive operations by generating at least one case insensitive hash entry based on at least one case sensitive stored file name of the plurality of case insensitive stored file names and adding the at least one case insensitive hash entry to the plurality of hash entries.

17. The system of claim 16, wherein the system is further configured to:
mark the at least one case sensitive stored file name as case sensitive;
update each of the plurality of file name entries to further include a case insensitive version of the respective file name of the file name entry; and
mark the updated file name entries as case insensitive.
